(19) United States
(12) Patent Application Publication
(10) Pub. No.: US 2007/0143512 A1
(43) Pub. Date: Jun. 21, 2007

(54) COMMUNICATION CIRCUIT OF SERIAL PERIPHERAL INTERFACE (SPI) DEVICES

(75) Inventor: HENG-CHEN KUO, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,708

(22) Filed: Sep. 15, 2006

(30) Foreign Application Priority Data
Dec. 17, 2005 (CN) 200510120957.0

(51) Int. Cl. G06F 13/00

(52) U.S. Cl. 710/110

(57) ABSTRACT

A communication circuit of serial peripheral interface (SPI) devices includes a master device, a plurality of slave devices, an SPI bus, and a multiplexer. The master device includes an SPI bus controller and a chip-selecting unit. Each of the slave devices is electrically coupled to the multiplexer. The multiplexer is electrically coupled to the SPI bus controller of the master device via the SPI bus. The chip-selecting unit of the master device is electrically coupled to the multiplexer for selecting one of the slave devices to communicate with the SPI bus controller via the multiplexer and the SPI bus.

### 1. FIELD OF THE INVENTION

The present invention relates to a communication circuit of serial peripheral interface (SPI) devices.

### 2. DESCRIPTION OF RELATED ART

In computer technology, a serial peripheral interface (SPI) is a communication interface for data communications between a master device such as a central processing unit (CPU) of a computer and slave devices such as peripheral chips of the computer.

Referring to FIG. 1, a communication circuit of SPI devices of a computer system is shown. The circuit includes a CPU 50 as a master device, and four peripheral chips 60 as slave devices. The chips 60 are electrically coupled to an SPI bus 70 in parallel, and then electrically coupled to an SPI controller 52 of the CPU 50. Four selecting pins CS0, CS1, CS2, and CS3 such as four general purpose input/output (GPIO) pins of a chip-selecting unit of the CPU are respectively electrically connected to selecting pins of the four peripheral chips 60. The CPU 50 communicates with the peripheral chips 60 via the corresponding GPIO pin.

However, the SPI bus 70 needs to drive the four chips 60 or more, thus it may overstep a range of drive ability of the SPI bus 70 so as to interfere with communication therebetween. In addition, the four chips 60 are connected in parallel, so that the four chips 60 may disturb each other. Furthermore, because an amount of the chips is equal to an amount of the applied GPIO pins of the CPU 50, if the amount of the chips 60 is great, the amount of the GPIO pins of the CPU 50 will be also great, thereby the computer system will be more complex.

What is desired, therefore, is to provide a communication circuit of SPI devices which can avoid overreaching drive ability of the SPI bus, and can reduce the amount of the selecting pins of the master device.

### SUMMARY OF THE INVENTION

An exemplary communication circuit of serial peripheral interface (SPI) devices includes a master device, a plurality of slave devices, an SPI bus, and a multiplexer. The master device includes an SPI bus controller and a chip-selecting unit. Each of the slave devices is electrically coupled to the multiplexer. The multiplexer is electrically coupled to the SPI bus controller of the master device via the SPI bus. The chip-selecting unit of the master device is electrically coupled to the multiplexer for selecting one of the slave devices to communicate with the SPI bus controller via the multiplexer and the SPI bus.

Other advantages and novel features will become more apparent from the following detailed description when taken in conjunction with the accompanying drawings, in which:

### BRIEF DESCRIPTION OF THE DRAWINGS

FIG. 1 is a block diagram of a conventional communication circuit of SPI devices; and

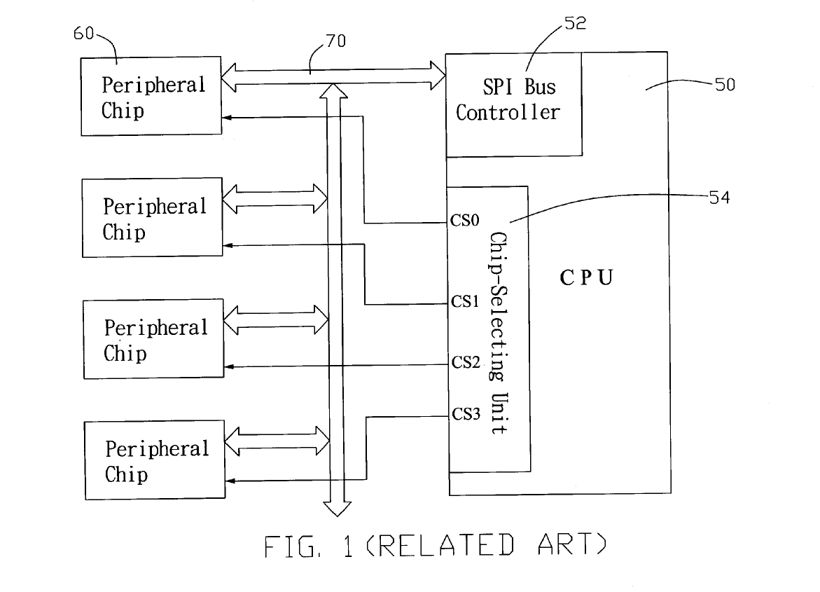

FIG. 2 is a block diagram of a communication circuit of SPI devices in accordance with a preferred embodiment of the present invention.

### DETAILED DESCRIPTION OF THE INVENTION

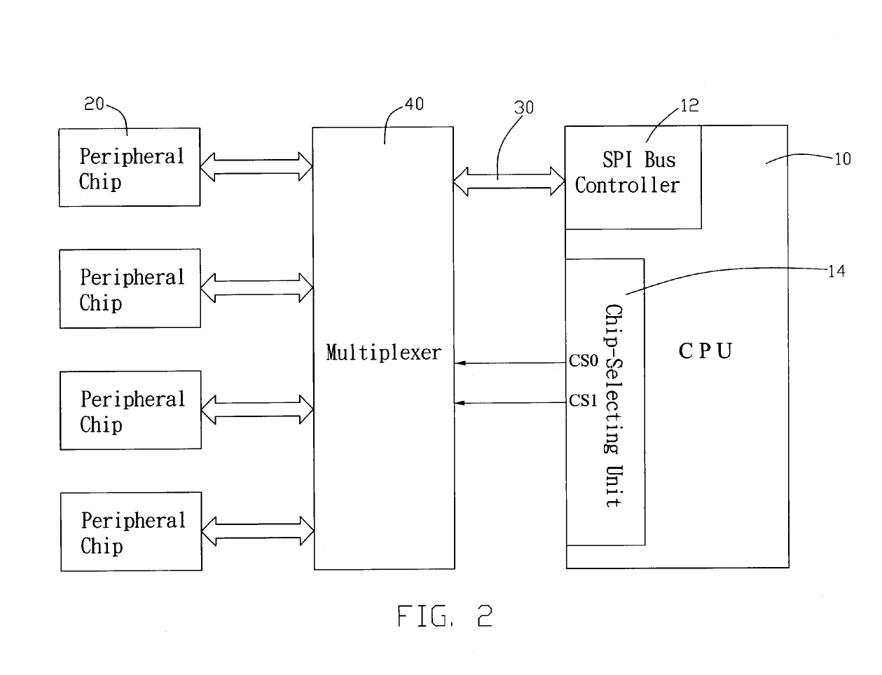

Referring to FIG. 2, a communication circuit of serial peripheral interface (SPI) devices in accordance with a preferred embodiment of the present invention is shown. The communication circuit includes a master device such as a CPU 10 of a computer system, a plurality of slave devices such as four peripheral chips 20 of the computer system, an SPI bus 30, and a multiplexer 40.

The CPU 10 includes an SPI bus controller 12 for receiving data from the SPI bus 30, and a chip-selecting unit 14 for selecting one of the peripheral chips 20 to communicate with the CPU 10. In this embodiment, the chip-selecting unit 14 includes two selecting pins such as general purpose input/output (GPIO) pins CS0 and CS1.

Each peripheral chip 20 is electrically coupled to the multiplexer 40. The multiplexer 40 is electrically coupled to the SPI bus controller 12 via the SPI bus 30. The GPIO pins CS0 and CS1 of the chip-selecting unit 14 of the CPU 10 are electrically coupled to two selecting pins of the multiplexer 40. If an amount of the peripheral chips 20 is m, and an amount of the GPIO pins is n, the following relationship must be satisfied:

2ⁿ⁻¹<m≦2″

Wherein, m is greater than 1. Because in this embodiment, the amount of the chips 20 is four, according to the above relationship formula, two GPIO pins CS0 and CS1 are enough. When voltage levels of the GPIO pins CS0 and CS1 are low, the multiplexer 40 will make one of the chips 20 communicate with the SPI bus controller 12. When the voltage level of the GPIO pin CS0 is low, and the voltage level of the GPIO pin CS1 is high, the multiplexer 40 will make another one of the chips 20 communicate with the CPU 10 via the SPI bus controller 12. Similarly, other two voltage level combinations of the GPIO pin CS0 and CS1 will respectively control the multiplexer 40 to select the other two chips 20 to communicate with the CPU 10 via the SPI bus controller 12.

Because the chips 20 are not directly connected to the CPU 10, but the multiplexer 40 instead, the SPI bus 30 will not overstep a range of drive ability thereof. In addition, the multiplexer 40 allows only one of the chips 20 to communicate the CPU 10 at one time, so that the chips 20 will not disturb each other. Further, the multiplexer 40 will reduce an amount of the GPIO pins of the chip-selecting unit 14 required, thereby reducing design complexity of the computer system.

It is to be understood, however, that even though numerous characteristics and advantages of the preferred embodiments have been set forth in the foregoing description, together with details of the structures and functions of the embodiments, the disclosure is illustrative only, and changes may be made in detail, especially in matters of shape, size, equivalent material and arrangement of parts within the principles of the invention to the full extent indicated by the broad general meaning of the terms in which the appended claims are expressed.

What is claimed is:

1. A communication circuit of serial peripheral interface (SPI) devices, comprising:
a master device comprising an SPI bus controller, and a chip-selecting unit;
a plurality of slave devices;
an SPI bus; and
a multiplexer, each of the slave devices electrically coupled to the multiplexer, the multiplexer electrically coupled to the SPI bus controller of the master device via the SPI bus, the chip-selecting unit of the master device electrically coupled to the multiplexer for selecting one of the slave devices to communicate with the SPI bus controller via the multiplexer and the SPI bus.

2. The communication circuit as claimed in claim 1, wherein the chip-selecting unit includes a plurality of selecting pins electrically connected to the multiplexer.

3. The communication circuit as claimed in claim 2, wherein the selecting pins are general purpose input/output (GPIO) pins.

4. The communication circuit as claimed in claim 2, wherein an amount of the slave devices and an amount of the selecting pins of the chip-selecting unit satisfy
2ⁿ⁻¹<m≦2″
wherein m is greater than 1, m is the amount of the slave devices, n is the amount of the selecting pins of the chip-selecting unit.

5. The communication circuit as claimed in claim 1, wherein the master device is a CPU of a computer system.

6. The communication circuit as claimed in claim 5, wherein the slave devices are peripheral chips of the computer system.

7. A computer system comprising:
a central processing unit (CPU) comprising an SPI bus controller, and a plurality of general purpose input/output (GPIO) pins;
a multiplexer electrically coupled to the SPI bus controller of the CPU via a SPI bus, the GPIO pins of the CPU electrically coupled to the multiplexer; and
a plurality of peripheral chips electrically coupled to the multiplexer for communicating with the CPU via the multiplexer and the SPI bus under the control of the GPIO pins.

8. The computer system as claimed in claim 7, wherein an amount of the peripheral chips and an amount of the GPIO pins of the CPU satisfy:
2ⁿ⁻¹<m≦2″
wherein m is greater than 1, m is the amount of the peripheral chips, n is the amount of the GPIO pins of the CPU.
